(19) United States
(12) Patent Application Publication
(10) Pub. No.: US 2018/0322427 A1
(43) Pub. Date: Nov. 8, 2018

(54) SYSTEM AND METHOD FOR TIME CRITICAL AUTOMATION

(71) Applicant: International Business Machines Corporation, Armonk, NY (US)

(72) Inventors: Guang Yu Dai, Ningbo (CN); Jing Bo Jiang, Beijing (CN); Wen Jing Wang, Beijing (CN); Ying UW Wang, Beijing (CN); Xin TY Xu, Beijing (CN); Jie BJ Zheng, Beijing (CN)

(21) Appl. No.: 15/586,925

(22) Filed: May 4, 2017

(51) Int. Cl. G06Q 10/06

(52) U.S. Cl. CPC G06Q 10/06313; G06Q 30/08

(57) ABSTRACT

The present invention is a system and method for forecasting automation timing behavior based on historical automation logs and business rules. The system includes a computer processor having a non-transitory memory containing program code for executing playback of an automation log, identifying a timing related failure in the automation log, extracting automation time-action mapping from the automation log, executing one or more scripts, comparing a baseline playback time from the automation log to an actual playback time from executing the scripts, and calculating a wait time based on differences between the actual playback time and the baseline playback time. The system generates time flexible scripts and a baseline or pattern to control the pace of automation scripts, which can be applied to other solutions. Therefore, the system distills patterns and generates predictive analysis and recommendations for other solutions and domains.

### BACKGROUND

The present invention relates generally to automation, and more particularly to generating an automation timing pattern based on log data analysis and applying it to different solutions.

Automation has been long adopted and applied to many business domains to increase product quality and testing coverage. Although there are maturity automation frameworks and tools, a proven method to manage automation playback for time-critical scenarios, such as online auction and bidding, and online gaming, for example, is lacking. Current automation has problems stemming from the fact that they lack timing flexible scripts and predictive analysis baseline or pattern control of the pace of automation scripts.

There have been some technologies and methods developed to remedy current automation. Related technologies and methods include utilizing execution logs to identify execution timing issues based on predictive analysis and pattern recommendation based on application characteristics. Traditional GUI automation simulation simulates a serial of manual activities chronologically in a single machine. However, when a set of inputs in the system depend on the timing and status of outputs, simple pipeline execution may result in failure.

A current solution to the problem is to debug or tune the scripts manually. However, although manual debugging and tuning is possible, it is time consuming, especially for scenarios involving multiple users for multiple rounds of actions. Manual debugging is difficult and often error-prone. Tuning is time-consuming because scripts tuned against one environment need to be re-tuned when playing back in a different environment. Even in the same environment, re-do effort is required due to different workload or network latency of the testing environment.

Therefore, there is a need for a system to generate timing flexible scripts and generate a baseline or pattern to control the pace of automation scripts, which can be applied to other solutions. Further, there is a need for a system to distill patterns and generate predictive analysis and recommendation for other solutions and domains.

### SUMMARY

The present invention is a system and method for time critical automation. The system includes a computer processor having a non-transitory memory containing program code for executing playback of an automation log, executing one or more scripts, analyzing automation logs to generate automation time baseline in a first environment, comparing the automation time baseline to an actual playback time for the scripts, calculating a wait time based on differences between the actual playback time and the automation time baseline, and adjusting the timing of one or more actions of the scripts.

Another embodiment of the present invention is a computer program product providing time critical automation. The computer program comprises a computer readable storage medium having program instructions embodied therewith. The computer readable storage medium is not a transitory signal per se. The program instructions are readable by a computer to cause the computer to perform a method comprising the steps of executing playback of an automation log, identifying a timing related failure in the automation log, extracting automation time-action mapping from the automation log, executing one or more scripts, comparing a baseline playback time from the automation log to an actual playback time from executing the scripts, and calculating a wait time based on differences between the actual playback time and the baseline playback time.

An additional embodiment of the present invention is a method for time critical automation. The method includes the steps of executing playback of an automation log, executing one or more scripts, analyzing automation logs to generate automation time baseline in a first environment, comparing the automation time baseline to an actual playback time for the scripts, calculating a wait time based on differences between the actual playback time and the automation time baseline, and reducing the wait time of one or more actions of the scripts.

### BRIEF DESCRIPTION OF THE DRAWINGS

The present invention will be more fully understood and appreciated by reading the following Detailed Description in conjunction with the accompanying drawings, in which:

FIG. 1 is a conceptual diagram of a non-limiting illustrative embodiment of the user actions based on business rules;

FIG. 2 is a conceptual diagram of a non-limiting illustrative embodiment of the system for time critical automation;

FIG. 3 is a flowchart of a non-limiting illustrative embodiment of the workflow of the system for time critical automation;

FIG. 4 is a conceptual diagram of a non-limiting illustrative embodiment showing time analysis of the system for time critical automation; and

FIG. 5 is a diagram of a non-limiting illustrative embodiment of scripts playback of a distributed environment.

### DETAILED DESCRIPTION

Referring to the Figures, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

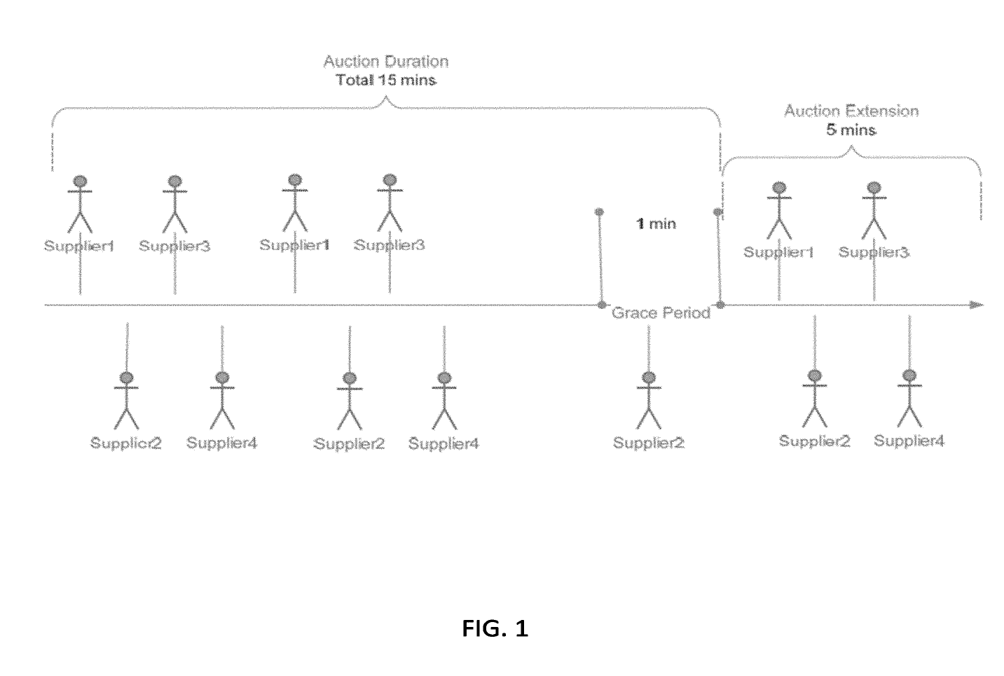

Referring again to the drawings, wherein like reference numerals refer to like parts throughout, there is shown in FIG. 1 a conceptual diagram of a non-limiting illustrative embodiment of the user actions based on business rules. The task completion time extension is only triggered by specific user action within predefined time duration or time point. As shown in the depicted embodiment, the predefined time duration is within the last one minute for the sample described. Tasks or user actions allowed in extra time are to be completed in fixed extension time, such as the 5 minutes shown in FIG. 1. However, the perfect timing of the depicted user scenario works in one environment, but will not be guaranteed to work in another environment.

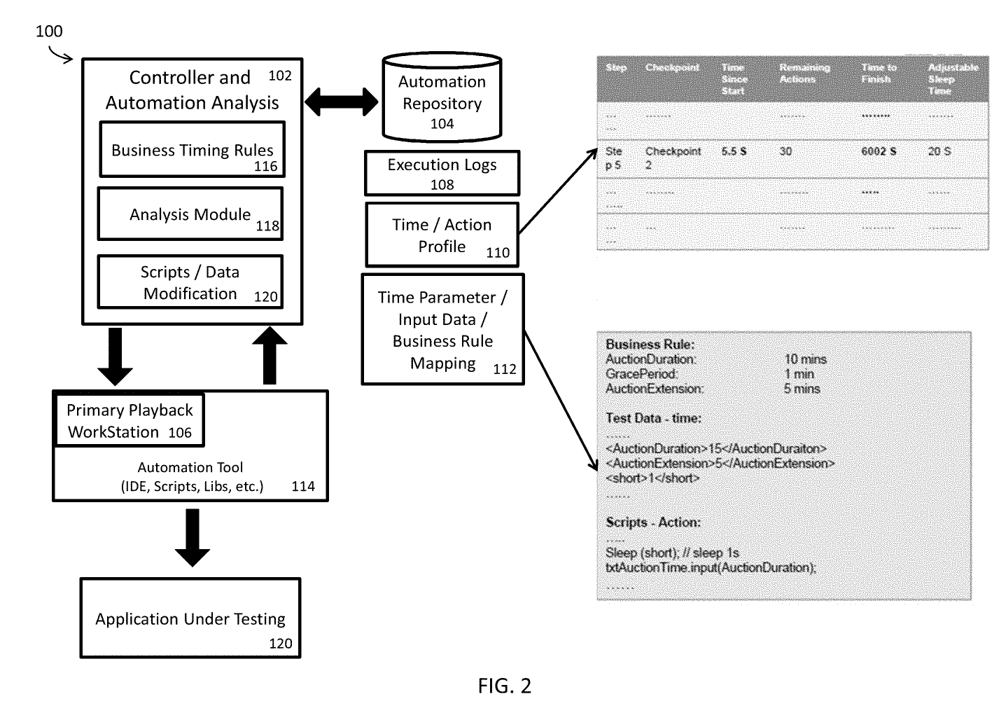

Referring now to FIG. 2, there is shown a conceptual diagram of a non-limiting illustrative embodiment of the system for time critical automation. The system 100 is a computer system comprising a controller 102, which is connected to and exchanges data with both an automation repository 104 and a primary playback workstation 106. The automation repository 104 comprises the execution (automation) logs 108, time/action profiles 110, and time related parameters, input data, and business rule mapping 112. The primary playback workstation 106 comprises an automation tool 114, such as IDE, scripts, or libs, for example. The controller 102 conducts automation analysis via its analysis module 118 with business timing rules 116 and modifies scripts and data 120. The primary playback workstation 106 provides updated automation tools 114, such as scripts, to the application under testing 120.

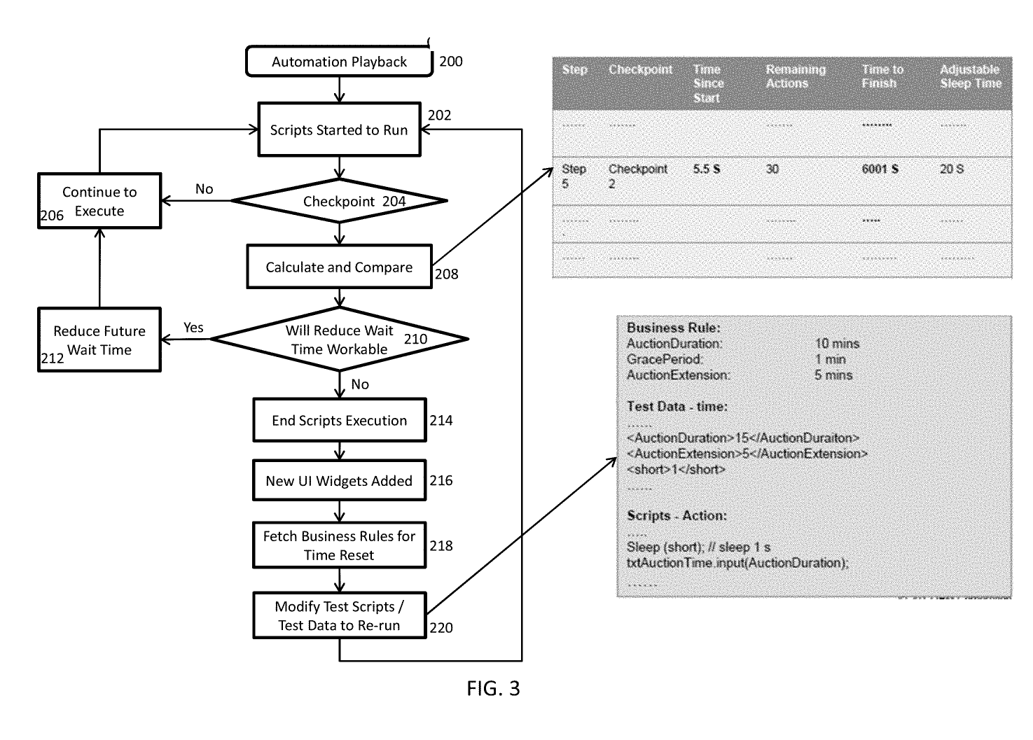

Referring now to FIG. 3, there is shown a flowchart of a non-limiting illustrative embodiment of the workflow of the system for time critical automation. At the first step 200, there is automation playback, which is playback of an automation log. Next, at step 202, the scripts start to run until step 204 when there is a checkpoint. The checkpoint compares the value stored in the test, i.e., the baseline value, with the actual value. If the checkpoint is not passed, the scripts continue to execute at step 206 and the method is repeated starting at step 202 in which the scripts run until the checkpoint at step 204. If the checkpoint is passed, the wait time is calculated and compared at step 208. The wait time is calculated based on differences between the baseline value and the actual value. At step 210, it is determined whether the wait time workable will be reduced. If the wait time workable is reduced, at step 212, the future wait time is reduced and the scripts again continue to execute at step 206 before they start to run. If the wait time workable is not reduced, the execution of scripts ends at step 214. Then, at step 216, new UI widgets are added. Next, at step 218, the business rules for time reset are fetched. Other time related parameters may be fetched as well. Such time related parameters may include a browser session-timeout limit, a screensaver limit, and a bidding auction time in an automation test case, for example. Finally, the test scripts are modified and the test data is re-run at step 220. In one embodiment, the test scripts are modified by business rules. In alternative embodiments, the test scripts are modified by other time related parameters, such as those listed above, or a combination of business rules and other time related parameters. In yet another embodiment, the test scripts are modified by a mapping structure comprising the automation logs, actions of the scripts, and business timing rules. Thereafter, the process starts again with the scripts starting to run at step 202.

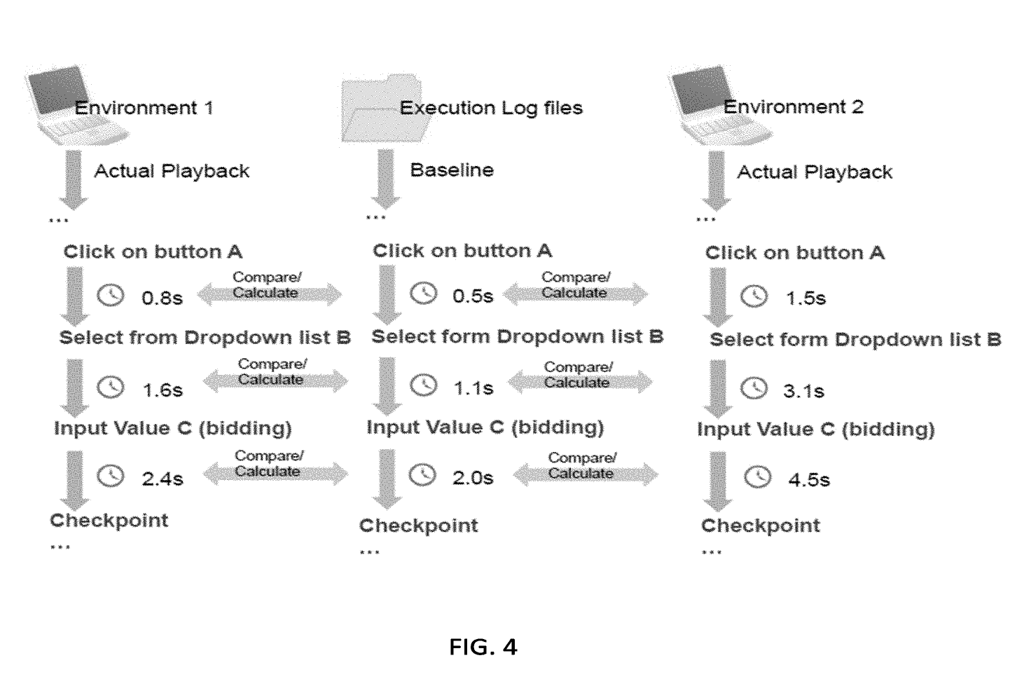

Referring briefly to FIG. 4, there is shown a conceptual diagram of a non-limiting illustrative embodiment showing time analysis of the system. FIG. 4 shows the time analysis of step 208 for Environment 1 and Environment 2 as compared to baseline time from historical execution logs. The timing for each action is calculated and compared to the baseline values in the execution log files. The comparison data is used to determine whether the script will successfully pass the checkpoint.

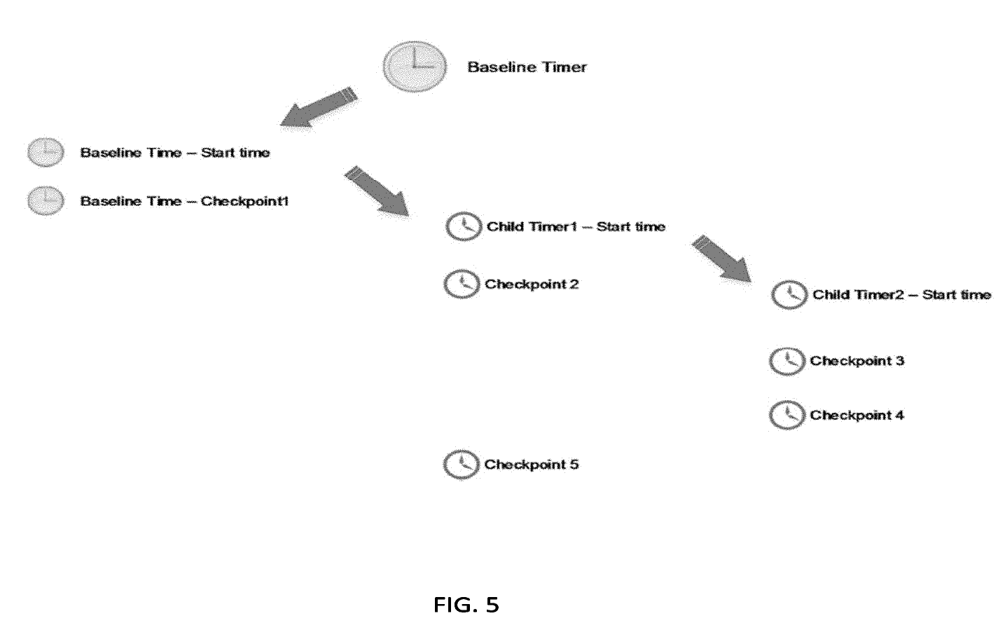

Referring now to FIG. 5, there is shown a diagram of a non-limiting illustrative embodiment of scripts playback of a distributed environment. As shown in the depicted embodiment, the baseline timer has a start time and a subsequent checkpoint. Thereafter, a first child timer has a start time and a first checkpoint. When the first child timer reaches its first checkpoint, second child timer has a start time. The second child timer encounters two checkpoints and thereafter, the first child timer reaches its second checkpoint. This describes the scripts playback of a distributed environment.

Thus, the system leverages existing automation artifacts, such as manual test cases, automation scripts and logs, and test data, to implement automation timing related behavior adjustment during playback without manual effort or intervention. The system also adjusts scripts to work on different testing environments and for different timing related business rules. Finally, the system works for distributed scripts playback, as needed.

While embodiments of the present invention has been particularly shown and described with reference to certain exemplary embodiments, it will be understood by one skilled in the art that various changes in detail may be effected therein without departing from the spirit and scope of the invention as defined by claims that can be supported by the written description and drawings. Further, where exemplary embodiments are described with reference to a certain number of elements it will be understood that the exemplary embodiments can be practiced utilizing either less than or more than the certain number of elements.

What is claimed is:

1. A computer processing system comprising:
a computer processor having a non-transitory memory containing program code for:
executing playback of an automation log;
executing one or more scripts;
analyzing automation logs to generate automation time baseline in a first environment;
comparing the automation time baseline to an actual playback time for the scripts;
calculating a wait time based on differences between the actual playback time and the automation time baseline; and
adjusting the timing of one or more actions of the scripts.

2. The system of claim 1, wherein the timing of one or more actions of the scripts are adjusted based on at least one of business rules and time related parameters.

3. The system of claim 1, further comprising the step of identifying timing related failure during playback

4. The system of claim 1, wherein the step of comparing the automation time baseline to an actual playback time for the scripts occurs at a checkpoint.

5. The system of claim 2, wherein the time related parameters are arranged in a mapping structure.

6. The system of claim 2, further comprising the step of running playback of the scripts against a second environment after the timing of the scripts is adjusted.

7. A computer program product providing time critical automation, the computer program comprising a computer readable storage medium having program instructions embodied therewith, wherein the computer readable storage medium is not a transitory signal per se, the program instructions are readable by a computer to cause the computer to perform a method comprising the steps of:
executing playback of an automation log;
identifying a timing related failure in the automation log;
extracting automation time-action mapping from the automation log;
executing one or more scripts;
comparing a baseline playback time from the automation log to an actual playback time from executing the scripts; and
calculating a wait time based on differences between the actual playback time and the baseline playback time.

8. The method of claim 7, further comprising the step of reducing the wait time of one or more actions of the scripts.

9. The method of claim 7, further comprising the step of terminating execution of the scripts.

10. The method of claim 7, further comprising the step of adding user interface widgets to the scripts.

11. The method of claim 7, further comprising the step of fetching business rules for time reset.

12. The method of claim 11, further comprising the step of modifying the scripts with business rules.

13. The method of claim 11, further comprising the step of modifying the scripts with time related parameters.

14. A method for time critical automation, comprising the steps of:
executing playback of an automation log;
executing one or more scripts;
analyzing automation logs to generate automation time baseline in a first environment;
comparing the automation time baseline to an actual playback time for the scripts;
calculating a wait time based on differences between the actual playback time and the automation time baseline; and
reducing the wait time of one or more actions of the scripts.

15. The method of claim 13, further comprising the step of receiving at least one of business rules and time related parameters.

16. The method of claim 14, further comprising the step of adjusting the timing of the actions of the scripts based on the at least one of business rules and time related parameters.

17. The method of claim 15, further comprising the step of testing the scripts against a second environment.

18. The method of claim 14, further comprising the step of generating a mapping structure comprising automation logs, actions of the scripts, and business timing rules.

19. The method of claim 17, further comprising the step of modifying the scripts using the mapping structure.
